(19) United States
(12) Patent Application Publication
(10) Pub. No.: US 2020/0082247 A1
(43) Pub. Date: Mar. 12, 2020

(54) AUTOMATICALLY ARCHITECTURE SEARCHING FRAMEWORK FOR CONVOLUTIONAL NEURAL NETWORK IN RECONFIGURABLE HARDWARE DESIGN

(71) Applicant: Kneron (Taiwan) Co., Ltd., Taipei City (TW)

(72) Inventors: JIE WU, San Diego, CA (US); JUNJIE SU, San Diego, CA (US); Chun-Chen Liu, San Diego, CA (US)

(21) Appl. No.: 16/554,634

(22) Filed: Aug. 29, 2019

Related U.S. Application Data
(60) Provisional application No. 62/728,076, filed on Sep. 7, 2018.

(51) Int. Cl. G06N 3/04; G06N 3/08

(52) U.S. Cl. CPC G06N 3/0445; G06N 3/08

(57) ABSTRACT

A searching framework system includes an arithmetic operating hardware. When operating the searching framework system, input data and reconfiguration parameters are inputted to an automatic architecture searching framework of the arithmetic operating hardware. The automatic architecture searching framework then executes arithmetic operations to search for an optimized convolution neural network (CNN) model and outputs the optimized CNN model.

### CROSS REFERENCE TO RELATED APPLICATIONS

This application claims the benefit of U.S. Provisional Application No. 62/728,076, filed Sep. 7, 2018 which is incorporated herein by reference.

### BACKGROUND OF THE INVENTION

### 1. Field of the Invention

This present invention is related to machine learning technology, in particular, a searching framework system configurable for different hardware constraints to search for the optimized neural network model.

### 2. Description of the Prior Art

Convolutional neural network (CNN) is recognized as one of the most remarkable neural networks achieving significant success in machine learning, such as image recognition, image classification, speech recognition, natural language processing, and video classification. Because of a large amount of data sets, intensive computational power, and higher demand for memory storage, the CNN architecture becomes more and more complicate and difficult to achieve a better performance, making a resource limited embedded system with a low memory storage and low computing capabilities, such as a mobile phone and video monitor unable to be implemented with the CNN architecture.

More specifically, the hardware configurations are different in different devices. Different hardware has different capabilities to support related CNN architectures. To achieve best applications' performance under the reconfigurable hardware constraints, it is critical to search for the best CNN architecture to fit the hardware constraints.

### SUMMARY OF THE INVENTION

An embodiment discloses a method for operating a searching framework system. The searching framework system comprises an arithmetic operating hardware. The method comprises inputting input data and reconfiguration parameters to an automatic architecture searching framework of the arithmetic operating hardware. The automatic architecture searching framework executes arithmetic operations to search for an optimized convolution neural network (CNN) model, and outputs the optimized CNN model.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a searching framework system according to an embodiment of the invention.

FIG. 2 illustrates an embodiment of the automatically architecture searching framework 106.

FIG. 3 illustrates an embodiment of an automatically architecture searching framework system.

### DETAILED DESCRIPTION

The present invention provides an automatically architecture searching framework (AUTO-ARS) that outputs an optimized convolution neural network (CNN) model under the reconfigurable hardware constraints.

FIG. 1 illustrates a block diagram of a searching framework system 100 according to an embodiment of the invention. The searching framework system 100 comprises an arithmetic operating hardware 108. The arithmetic operating hardware 108 has an automatic architecture searching framework 106 executed thereon. Input data 102 and reconfiguration parameters 104 are inputted to the automatic architecture searching framework 106. The automatic architecture searching framework 106 executes arithmetic operations to search for the optimized CNN model 110. The optimized CNN model 110 is the optimized CNN data which fits hardware constraints.

The reconfiguration parameters 104 comprise the hardware configuration parameters such as memory size and computing capability of the arithmetic operating hardware 108. The input data 102 can be multimedia data, such as images and/or voices. The automatic architecture searching framework 106 executes arithmetic operations to search for the optimized CNN model. The optimized CNN model 110 includes application task lists such as classification, object detection, segmentation, etc.

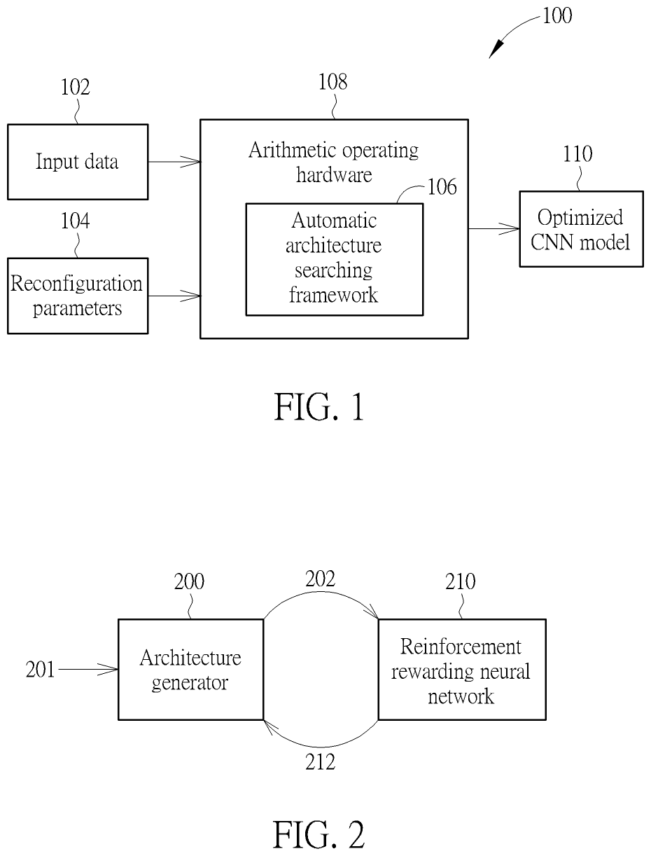

FIG. 2 illustrates an embodiment of the automatically architecture searching framework 106. The automatically architecture searching framework 106 is implemented by an architecture generator 200 and a reinforcement rewarding neural network 210. In the automatically architecture searching framework 106, initial input data 201 is inputted to the architecture generator 200 for generating updated CNN data 202. The initial input data 201 can be multimedia data comprises images and/or voice. Then, the updated CNN data 202 is inputted to the reinforcement rewarding neural network 210 for generating reinforced CNN data 212. Further, the reinforced CNN data 212 can be inputted to the architecture generator 200 to generate for refreshing updated CNN data 202. In other words, the architecture generator 200 and the reinforcement rewarding neural network 210 forms a recursive loop for performing a recursive refresh process of the updated CNN data 202 and the reinforced CNN data 212. The recursive refresh process terminates and the optimized CNN model is outputted when a validation accuracy reaches a predetermined value.

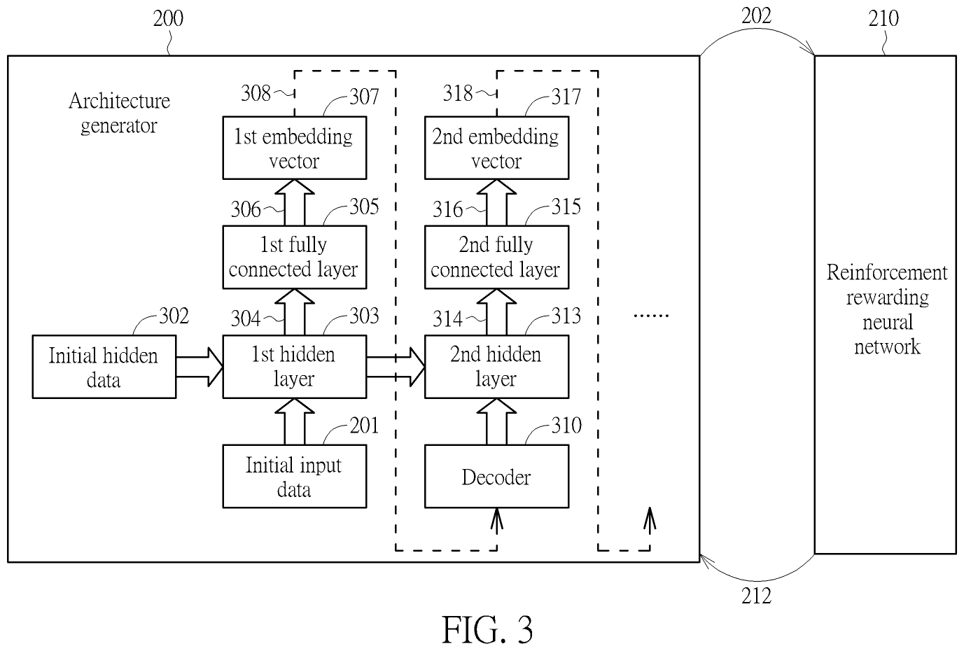

FIG. 3 illustrates an embodiment of a block diagram of the architecture generator 200. The architecture generator 200 is implemented as a recurrent neural network. In the architecture generator 200, the initial input data 201 and initial hidden data 302 are inputted to a 1^{st} hidden layer 303 to perform a hidden layer operation for generating 1^{st} hidden layer data 304. The hidden layer operation comprises weight, bias and activation arithmetic operations. Then, the 1^{st} hidden layer data 304 is inputted to a 1^{st} fully connected layer 305 to perform a fully connected operation for generating 1^{st} fully connected data 306. The fully connected operation comprises weight, bias and activation arithmetic operations. Further, the 1^{st} fully connected data 306 is inputted to a 1^{st} embedding vector 307 to execute an embedding procedure for generating 1^{st} embedded data 308. The 1^{st} embedding vector 307 connects convolutional layers and activation layers of the fully connected data 306 to generate the 1^{st} embedded data 308.

The 2^{nd} level of the recurrent neural network will then execute. The 1^{st} embedded data 308 is inputted to a decoder 310 to generate 1^{st} decoded data 311. Then, the 1^{st} decoded data 311 and the 1^{st} hidden layer data 304 are inputted to a 2^{nd} hidden layer 313 to perform a hidden layer operation for generating 2^{nd} hidden layer data 314. Further, the 2^{nd} hidden layer data 314 is inputted to a 2^{nd} fully connected layer 315 to perform a fully connected operation for generating 2^{nd} fully connected data 316. The 2^{nd} fully connected data 316 is then inputted to a 2^{nd} embedding vector 317 to execute an embedding procedure for generating 2^{nd} embedded data 318.

As shown in the above steps, the 3rd level of the recurrent neural network will then follow. This process will keep going to next level of the recurrent neural network until the number of layers of the CNN data exceeds a predetermined number, then the updated CNN data will be outputted to the reinforcement rewarding neural network 210. In some embodiments, if the validation accuracy has reached the predetermined value before the number of layers of the CNN data exceeds the predetermined number, then the updated CNN data will be outputted as the optimized CNN model. In other embodiments, even if the validation accuracy has reached the predetermined value before the number of layers of the CNN data exceeds the predetermined number, the CNN data will keep updating until all levels of the recurrent neural network have updated the CNN data, and the reinforcement rewarding neural network 210 will then output the latest updated CNN data as the optimized CNN model.

The CNN data comprises convolution layers, activation layers, and pooling layers. The convolution layers comprise the number of filters, kernel size, and bias parameters. The activation layers comprise leaky relu, relu, prelu, sigmoid, and softmax functions. The pooling layers comprise the number of strides and kernel size.

The searching framework system 100 is configurable for different hardware constraints. The searching framework system 100 combines a convolution neural network, the architecture generator 200 and the reinforce rewarding neural network 210 for searching for the optimized CNN model 110. The architecture generator 200 predicts the components of neural network, such as convolutional layers with the number of filters, kernel size, and bias parameters, activation layers with different leaky functions, and etc. The architecture generator 200 generates hyper-parameters as a sequence of tokens. More specifically, the convolutional layers have their own tokens, such as the number of filters, kernel size, and bias parameters. The activation layers have their own activation functions, such as leaky relu, relu, prelu, sigmoid, softmax functions, and etc. The pooling layer has its own tokens, such as the number of stride and kernel size. All of these tokens for different types of layers are in the reconfigurable hardware configuration pool.

The process of updating CNN data stops when the number of layers in CNN data exceeds the predetermined number. Once the architecture generator 200 finishes updating the CNN data, a feed forward neural network satisfying the reconfigurable hardware configurations' constraint is built and can be passed to the reinforcement reward neural network 210 for training. The reinforcement reward network 210 takes the CNN data and train it until it converges. A validation accuracy of the proposed neural network is defined as an optimized result. By a policy gradient method, using the validation accuracy as a design metric, the architecture generator 200 will update its' parameters to re-generate the better CNN data over time. By updating the hidden layers, the optimized CNN model can be constructed. Applying the proposed techniques, the optimized CNN model is built within customized model size and acceptable computational complexity under reconfigurable hardware configurations' constraints.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for operating a searching framework system, the searching framework system comprising an arithmetic operating hardware, the method comprising:
inputting input data and reconfiguration parameters to an automatic architecture searching framework of the arithmetic operating hardware;
the automatic architecture searching framework executing arithmetic operations to search for an optimized convolution neural network (CNN) model; and
outputting the optimized CNN model.

2. The method of claim 1 wherein the optimized CNN model comprises classification, object detection and/or segmentation.

3. The method of claim 1 wherein the input data is multimedia data comprising images and/or voice.

4. The method of claim 1 wherein the reconfiguration parameters are related to memory size and computing capability of the arithmetic operating hardware.

5. The method of claim 1 wherein the automatic architecture searching framework executing the arithmetic operations to search for the optimized CNN model comprises:
inputting CNN data to an architecture generator to generate updated CNN data;
reinforcing the updated CNN data in a reinforcement rewarding neural network to generate reinforced CNN data; and
when a validation accuracy reaches a predetermined value, outputting the optimized CNN model.

6. The method of claim 5 wherein the automatic architecture searching framework executing the arithmetic operations to search for the optimized CNN model further comprises:
inputting the reinforced CNN data to an architecture generator.

7. The method of claim 5 wherein the CNN data comprises convolution layers, activation layers, and pooling layers.

8. The method of claim 7 wherein the convolution layers comprise number of filters, kernel size, and bias parameters.

9. The method of claim 7 wherein the activation layers comprise leaky relu, relu, prelu, sigmoid, and softmax functions.

10. The method of claim 7 wherein the pooling layers comprise number of strides and kernel size.

11. The method of claim 7 wherein the reinforcement rewarding neural network comprises rewarding functions.

12. The method of claim 5 wherein inputting the CNN data to the architecture generator to generate the updated CNN data comprises:
inputting the CNN data and initial hidden data to a hidden layer to perform a hidden layer operation for generating hidden layer data;
inputting the hidden layer data to a fully connected layer to perform a fully connected operation for generating fully connected data;
inputting the fully connected data to an embedding vector to execute an embedding procedure for generating embedded data;
inputting the embedded data to a decoder to generate decoded data; and
when number of layers in the CNN data exceeds a predetermined number, outputting the updated CNN data.

13. The method of claim 12 wherein inputting the CNN data to the architecture generator to generate the updated CNN data further comprises:
inputting the decoded data and the hidden layer data to next hidden layer to perform next hidden layer operation.

14. The method of claim 12 wherein the hidden layer is of a recurrent neural network.

15. The method of claim 12 wherein the hidden layer performs weight, bias and activation arithmetic operations to generate the hidden layer data.

16. The method of claim 12 wherein the fully connected operation performs weight, bias and activation arithmetic operations to generate the fully connected data.

17. The method of claim 12 wherein the embedding procedure is executed by connecting convolutional layers and activation layers of the fully connected data to generate the embedded data.
